(19) United States
(12) Patent Application Publication
(10) Pub. No.: US 2007/0208664 A1
(43) Pub. Date: Sep. 6, 2007

(54) Computer implemented online music distribution system

(76) Inventor: Jerome Alton Ortega, Miami, FL (US)

Correspondence Address: John S. Egbert;Egbert Law Offices, 7th Floor, 412 Main Street, Houston, TX, 77002, US

(21) Appl. No.: 11/360,852

(22) Filed: Feb. 23, 2006

(51) Int. Cl. H04L 9/00; G06Q 30/00

(52) U.S. Cl. 705/51; 705/14

(57) ABSTRACT

A computer implemented online music distribution system provides for the secure delivery of audio data and related media, including text and images, over the Internet. The online music distribution system provides a client-server system including a distribution server including a delivery server, and an HTTP server and or Secure Server, communicating with a client system. The system is completed with a music card to be purchased by the user. The card acts like a retail CD and downloadable with security measures on the buyers computer, while giving the artist, musician and record label some demographic information. The invention has lower production costs, lower shipping costs, easy distribution, unlimited resale points, anti-piracy measures, buyers basic information, no need for credit card transactions, unique secure download systems and illegal downloading protection, and a way to have record of purchases and full album royalties and income.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates generally to the field of online commerce, and more particularly, to a system for the online distribution of music over the Internet.

### BACKGROUND OF THE INVENTION

The rapid development of the Internet has primarily focused on the online commerce for the distribution of their products. From a commercial stand point, “distribution” means purchase and delivery. Most companies support both processes, the purchase phase online and the delivery phase using the well-known logistic Companies like Fedex or UPS. At present, the majority of products purchased in this manner are traditional and non-traditional products, including CDs, computers, furniture, books, clothing, food products, and the like. In case of the music products, the typical support media are CDs and DVDs.

There are other types of distribution channels for media products like music and video. In this case, is possible to purchase and deliver the product on-line, by completing the purchase process on line and then downloading the files to the customer's computer. Such an online distribution system presents a number of special challenges not associated with non-digital products. For example, with conventional distribution of music on CD and cassette tapes, losses from copyright infringement from illegal copying of music are estimated at about $1 billion worldwide, annually. The susceptibility of digital audio to unauthorized copying, and the ability to create perfect duplicates, means more significant losses to the music industry, and has been the single greatest factor in the music industry's reluctance to make music available for purchase over the Internet.

During the last few years, a number of online services were created offering music online. In many cases is possible to purchase the whole album of a determined artist, and in most of them is possible to buy just one single song of certain album. Even when this may seem to be favorable for the customer, we will demonstrate in this work that it is not.

First of all, any system that works against the interests of the musicians will only create a collapse in the long run. Even when it may sound obvious, there is no market without the musicians. There is a market because there are musicians creating music to be purchased. If the market finally tends to massively accept some of the present online distributing system that allows the customer to purchase online just one single song of a full album, like iTunes between many others, the whole system will collapse, because the revenues a system of this type creates for the musicians are not enough or attractive for them. Simple math will demonstrate that. By purchasing a single song of a whole album at $ 0.99 the musician gets approximately around 7-10% of this money, that is, around $ 0.07-0.10 per song. Instead, by purchasing the full album, the musician gets around $ 1 per album. This difference talks by itself.

Moreover, distributing CDs are sometimes cumbersome and expensive because of the volume of a set of several hundred of CDs. With the purposed system is easier to distribute the music support media to the retailers than the CDs or DVDs. Moreover, the CDs are easy to be copied since there is no available technology in the CDs industry to keep the media itself secure against unauthorized copying.

Therefore, the market needs something in between distributing CDs and downloading online on a song-by-song basis. The purpose of the present invention is to offer a new type of online solution for downloading music taking into account the interests of the most important actor of this market: the musicians.

It is possible to offer a system, by which the customer may download the full album at a price lower than a CD price, keeping the revenue stream of the musicians, the recording companies and the retailers. It is also possible to offer the possibility to the customers that want to be able to sample audio products prior to purchasing, to provide some mechanism by which users can play limited portions of songs and view related media without having to purchase the full album.

Similarly, purchasers of music in traditional forms such as compact disc or cassettes are accustomed to simple, easy to use consumer devices, such as portable compact disc players to tape players. For the successful distribution of music over the Internet, the security requirements must not unduly interfere with consumer's ease of use of the system. A consumer should be able to purchase and playback audio easily and securely. However, the security measures, particularly the encryption mechanisms, should make the purchased audio unusable outside of the specific devices and mechanism designed to cooperate with the distribution system.

Similarly, consumers are accustomed to being able to play music purchases anywhere they can carry a CD and CD player. Consumers will expect similar portability when purchasing digital media over the Internet. Accordingly, a desirable online music.distribution system should allow a consumer to playback purchased audio not merely on a single computer, but on any platform equipped with an appropriately licensed playback device and the licensee's personal identification.

Also, given the very high audio fidelity available today with conventional CD products, audio purchased over the Internet from an online music distribution system must have at least the same level of fidelity, or otherwise consumers will not purchase such products. Thus, any encryption or compression methods used must not induce significant signal loss, or impair playback performance.

Even when there already exist today various forms of online payment processing systems, the present invention purposes a new type by which the customer may purchase what is called a “music card”, that is a card including an alphanumeric code recorded on it. The customer must access to a website that offers the downloading system, and insert said alphanumeric code as an access code. Once the system validates said code, the customer will be allowed to download the full album of their choice. (on the face of the card)

There are several patents describing music distributions systems. Just as an example, U.S. Pat. No. 6,928,261 of Hasegawa, et al. describes a music data distribution system for distributing music data to an external device connected to a network, comprises: a storage device that stores first music data; a receiver that receives a music data distribution request from the external device connected to the network, the music data distribution request comprising at least music data identification information and music data quality information; a reading device that reads the first music data from said storage device in accordance with the music data identification information; a quality converter that converts the first music data into second music data having a quality different from the first music data in accordance with the music data quality information; and a transmitter that transmits the first or the second music data to the external device in accordance with contents of the music data distribution request.

U.S. Pat. No. 6,182,128 is referred to a music distribution system is divided into a plurality of regional networks each including a plurality of users. Each of the regional networks includes a distribution center to which the users of that region are connected. Each distribution center is provided with a library in which is stored a plurality of music titles. A user sends a request to the distribution center via an existing telephone network or cable network. Upon receiving the user's request, the distribution center locates and retrieves the requested data file stored in the regional library, and then transmits the requested file to the user via the existing cable service. At the user's destination, electronic equipment such as a television or a stereo receiver system may provide an audio/visual output of the requested data track.

U.S. Pat. No. 5,636,276 describes a device for the distribution of music information in digital form. In order to distribute music information from a central memory device via a communications network to a terminal, this information is organized in a digital music information object. The latter comprises a core having basic information relating to the music information object, as well as a number of additional layers having the actual music information. The core includes an encryption table, on the basis of which an encryption module of the central memory device and a decryption module of the terminal respectively encrypt and decrypt the music information object. Furthermore, an interpretation module is provided in the terminal for reproduction conditioning of the music information object, which interpretation module accesses information for checking the authorized use of the music information object, which information is stored in an authorization device and identifies the terminal or the consumer. The invention thus creates a technique for distribution of digital music information which on the one hand provides effective mechanisms for the protection of copyrights and on the other hand makes possible increased services for the consumer.

U.S. Pat. No. 6,868,403 is referred to a computer implemented online music distribution system provides for the secure delivery of audio data and related media, including text and images, over a public communications network. The online music distribution system provides security through multiple layers of encryption, and the cryptographic binding of purchased audio data to each specific purchaser. The online music distribution system also provides for previewing of audio data prior to purchase. In one embodiment, the online music distribution system is a client-server system including a content manager, a delivery server, and an HTTP server, communicating with a client system including a Web browser and a media player. The content manager provides for management of media and audio content, and processing of purchase requests. The delivery server provides delivery of the purchased media data. The Web browser and HTTP server provide a communications interface over the public network between the content manager and media players. The media player provides for encryption of user personal information, and for decryption and playback of purchased media data. Security of purchased media data is enhanced in part by the use of a personal, digital passport in each media player. The digital passport contains identifying information that identifies the purchaser, along with confidential information, such as credit card number, and encryption data, such as the media player's public and private keys. The media player encryption data is used to encrypt purchased media data, which is decrypted in real time by the media player. The media player also displays confidential information, such as the purchaser's credit card number, during playback.

### BRIEF SUMMARY OF THE INVENTION

The present invention provides a secure online music distribution system that provides consumers with flexibility and ease of use in downloading of audio and other digital media over the Internet, without affecting the interest of the musicians.

An online music distribution system in accordance with the present invention includes basically two main components, a variety of cooperative components that communicate over the Internet, and a network of retailers that offer the music cards with the alphanumeric code to access the delivery servers. These components include a content manager, at least one delivery server and HTTP servers and or Secure Server offering Internet communications. Purchasers get the alphanumeric access code by purchasing a music card in one of the retailer's stores; mainly any type of retailer stores may offer these cards, not only music stores, but also gas stations, supermarkets, etc. Once the customer purchases the card, there is a scratch-off zone on the back of the card that has the alphanumeric code recorded. The customer must get access to the website that offers this service over the Internet, and insert this code. Once the system validates said code, the customer will be allowed to download the full album and not just a single song like in other download systems.

By downloading the full album, the musician, the record label company and the retailers keep a revenue stream that justifies keeping the system running and the user is also of benefit because the final price of each album will be lower than the regular price of a CD.

Thus, the present invention is referred to a computer implemented online music distribution system provides for the secure delivery of audio data and related media, including text and images, over the Internet. The online music distribution system provides a client-server system providing delivery of the purchased media data. The system is completed with a music card to be purchased by the user at any retailer; said card includes a system access alphanumeric code the user uses to communicate with the client-server system through the Internet. Said alphanumeric code allows the user to download a complete music album of their choice to the customer's computer.

More specifically, the present invention is referred to a computer implemented online music distribution system, comprising a media data, a digital music distribution company having secure internet-connected servers in which the media data is uploaded, the digital music distribution company starts the distribution process by creating a set of secure server access alphanumeric codes, said codes are sent to a card manufacturer that manufactures a set of cards recording in each card one of the above cited access alphanumeric codes; the back face of said card includes a scratch-off zone underneath of which the access alphanumeric code is recorded; the cards are then distributed to retailer shops; the customer purchase the card at the retailer store, scratch-off the access code, access the artist dedicated website, insert the access code and download the full album download. (The front of the card shows the design, graphics, or name of the specific album, just like if it was a CD cover or packaging.)

### BRIEF DESCRIPTION OF THE SEVERAL VIEWS OF THE DRAWINGS

FIG. 1 is a schematic view of an illustration of a chart flow that describes how the purposed online music distribution system works.

FIG. 2 is another schematic view of an illustration of the music card.

### DETAILED DESCRIPTION OF THE INVENTION

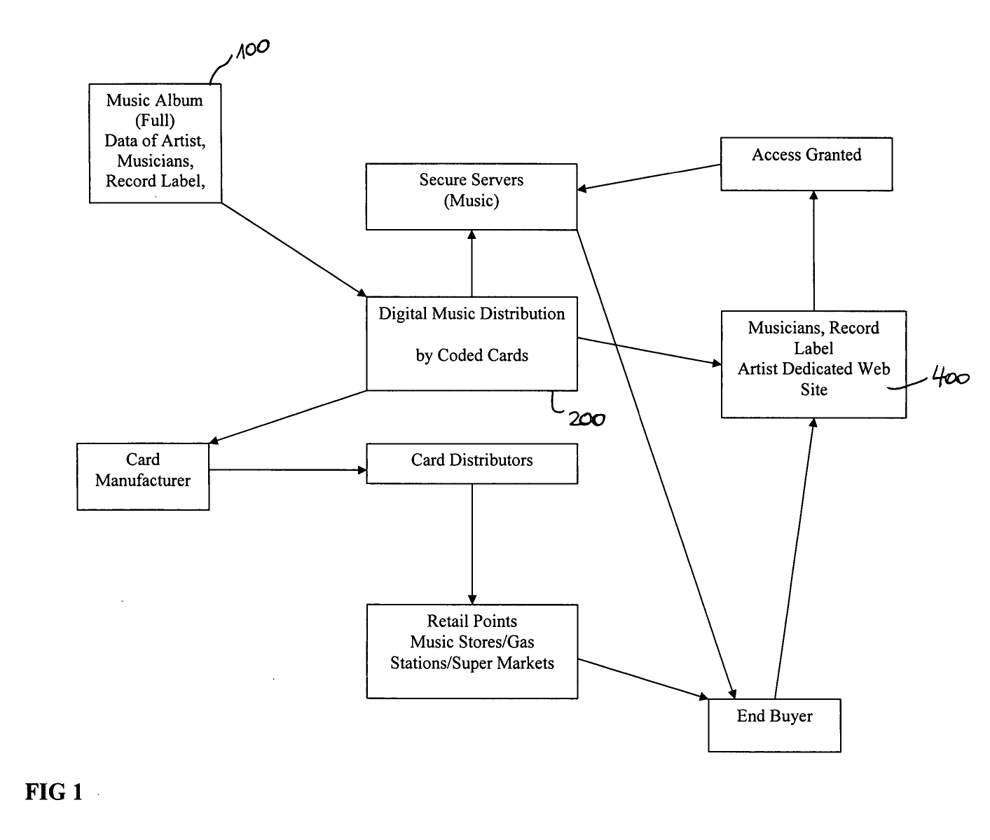

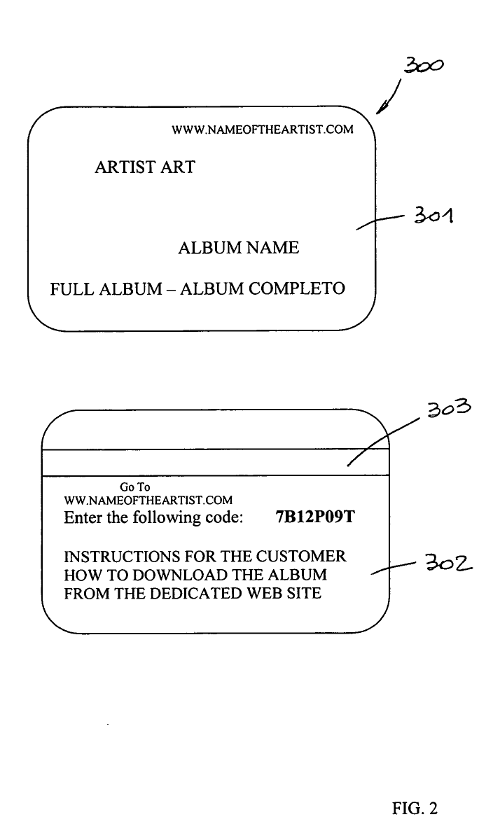

Referring to FIG. 1, the systems basically comprises media data 100, for example a full album of an artist including artist info, lyrics of this album, record label data, etc. This media data creates author rights capable to be licensed to a digital music distribution company 200. Said digital music distribution company 200 have a set of secure internet-connected servers in which the full album 100 is uploaded by digitalizing and mp3 compressing said album, including the album art, lyrics, etc. Once the digital music distribution company 200 acquires the license of said album, starts the distribution process by creating a set of secure server access alphanumeric codes that will allow to the customer to download said album to their computer. Said codes are sent to a card manufacturer that manufactures a set of cards recording in each card one of the above cited access alphanumeric codes. Each card (see FIG. 2) comprises a plastic rectangular card 300, similar to a credit card that included in the front face 301 the name of the artist, the name of the album, and the address of the website the customer must use to download the full album. The back face 302 includes a magnetic strip 303; a brief instruction the customer must follow to download the music, and a scratch-off zone underneath of which the access alphanumeric code is recorded.

Once the card manufacturer manufactures the set of cards, send them to the card distributors that will distribute these cards to any type of retailer interested in selling this type of products. It is import to stand out that not only the music stores will be the sale points of this product, but also gas stations, mini and supermarkets, and any other retailer shop.

Once the customer purchase the card at the retailer store, must first scratch-off the access code. Then the artist dedicated website 400 must be accessed and the access code must be inserted in the appropriate field to allow the full album download. In order to be able to do that, the customer must insert their e-mail address together with the access code. This is important as this allows to the artist to get information from the customers, basically the e-mail address. This important information may be used to inform to the customers about new albums recorded by this artist, or information about live shows the artist may offer in a location near to the customer address.

Once the secure servers validates the access code inserted by the customer and registers the customer's information, like the e-mail address, allows the customer to download the full album to the customer's computer. Once the full album is downloaded, the customer is free to burn a CD with this music, download it to a portable device like a mp3 player or an iPod, etc.

I claim:

1. Computer implemented online music distribution system, comprising:
a media data, a digital music distribution company having secure internet-connected servers in which the media data is uploaded, the digital music distribution company starts the distribution process by creating a set of secure server access alphanumeric codes, said codes are sent to a card manufacturer that manufactures a set of cards recording in each card one of the above cited access alphanumeric codes; the back face of said card includes a scratch-off zone underneath of which the access alphanumeric code is recorded; the cards are then distributed to retailer shops; the customer purchase the card at the retailer store, scratch-off the access code, access the artist dedicated website, insert the access code and download the full album download.

2. Computer implemented online music distribution system, in accordance to claim 1, wherein said media data is comprised of a music album.

3. Computer implemented online music distribution system, in accordance to claim 2, wherein said media data comprises artist data, lyrics of songs in said music album, and record label data.

4. Computer implemented online music distribution system, in accordance to claim 1, wherein said media data creates author rights capable to be licensed to the digital music distribution company.

5. Computer implemented online music distribution system, in accordance to claim 2, wherein said digital music distribution company has a set of secure internet-connected servers in which a full album is uploaded by digitalizing and mp3 compressing the album.

6. Computer implemented online music distribution system, in accordance to claim 1, wherein said digital music distribution company starts the distribution process by creating a set of secure server access alphanumeric.

7. Computer implemented online music distribution system, in accordance to claim 1, wherein said codes are sent to a card manufacturer that manufactures a set of cards recording in each card one of the above cited access alphanumeric codes.

8. Computer implemented online music distribution system, in accordance to claim 7, wherein said codes are recorded on the back side of the cards, the code hidden in each card by covering the code with a scratch-off material.

9. Computer implemented online music distribution system, in accordance to claim 1, wherein each card comprises a plastic rectangular card, comprising on the front face the name of the artist, the name of the album, and the address of the website the customer must use to download the full album, and wherein said back face comprises a magnetic strip; a brief instruction the customer must follow to download the music, and a scratch-off zone underneath of which the access alphanumeric code is recorded.

10. Computer implemented online music distribution system, in accordance to claim 1, wherein a retailer store is comprised of music stores, gas stations, mini and supermarkets.
